(19) United States
(12) Patent Application Publication
(10) Pub. No.: US 2006/0114752 A1
(43) Pub. Date: Jun. 1, 2006

(54) Bracelet fastening device for watches and jewels

(75) Inventor: Andre Saunier, Courgenay (CH)

Correspondence Address: PEARNE & GORDON LLP, 1801 EAST 9TH STREET, SUITE 1200, CLEVELAND, OH, 44114-3108, US

(73) Assignee: Hart Case Corp., Purchase, NY (US)

(21) Appl. No.: 11/269,413

(22) Filed: Nov. 8, 2005

(30) Foreign Application Priority Data
Nov. 9, 2004 (CH) 2004CH-01845

(51) Int. Cl. G04B 37/00; A44C 5/00

(52) U.S. Cl. 368/281

(57) ABSTRACT

Bracelet fastening device for watches and jewels allowing the user to change the bracelet rapidly and without tool. The bracelet strand (3) is held by the horns (1) of the base element (9) that are not parallel to one another and that form a necking so as to resist to traction. The locking of the bracelet strand (3) along the vertical axis is ensured by a tongue (6) introduced in at least one recess (12) of the bracelet strand. The tongue is placed in this position following an action on a rotating element of the watch or jewel.

### REFERENCE DATA

This application claims priority from Swiss patent application CH01845/04 filed on Nov. 9, 2004 and from U.S. patent application US11/032927 filed on Jan. 11, 2005, the contents of which are hereby incorporated by reference.

### FIELD OF THE INVENTION

The present invention concerns a bracelet fastening or attaching device or connecting element for watches and jewels.

### DESCRIPTION OF RELATED ART

An important element of a watch's exterior is the bracelet allowing it to be fastened to the wrist.

The evolution of customs and fashions has created new needs, notably as regards the changing of the bracelet to adapt it to circumstances, clothing or current fashion.

Quality watches often use conventional bracelet fastening means, i.e. attachments or horns with a place for the bracelet's extremity. This bracelet can be of leather, metal or any other existing material suited for this use. In order to ensure that the bracelet is reliably fastened on the watch, it is necessary to make them integral along three axes, defined in space as described hereafter (FIG. 1):
the longitudinal axis B, represented by the watch's 6 o'clock-12 o'clock line,
the transverse axis A-C, parallel to the 3 o'clock-9 o'clock line,
the vertical axis, perpendicular to the other two axes B and A-C.

On most bracelet fastening systems, a cylindrical lug is used, of which at least one of the two pivots is mobile. This lug is integral with the bracelet's strand through a traversing opening made through the latter. The pivots are lodged in opposite borings provided to this effect in the horns of the watch. In this manner, the bracelet is integral with the watch, through the lug, on the longitudinal axis and on the vertical axis. The locking on the transverse axis is ensured in both directions by the attaching device of the watch since the distance in-between the horns is practically equal to the width of the bracelet's strand. Ordinarily, the inner sides of the horns, in which the borings are made to receive the lug's pivots, are parallel to one another, and generally parallel to the longitudinal axis 1 of the watch.

Changing the bracelet can thus be effected neither instantly nor easily by the watch's wearer. The latter must thus request the assistance of the vendor who uses suitable tools.

The present invention aims to provide a bracelet attaching device answering the new needs, as described here above, namely to allow the user to change the bracelet easily, without tools and reliably.

Many patents are known that have in common proposals for solving the same problem: how to change a watch bracelet oneself rapidly and without tool, yet ensuring the reliability of the clasp.

Patent EP0461069 proposes a rotating bezel provided with two protuberances which, in normal position, overlap over two other complementary protuberances that are part of the watch's middle and containing each a lodging for receiving the two strands of the bracelet provided with their respective lug. The inconvenience of this system is that it limits the possibilities of creating new shapes for the watch cases or for the jewel, because it compulsorily comprises a rotating bezel provided with protuberances.

Patent CH216721 uses the same principle of a rotating bezel overlapping over, and locking, the bracelet's fastening area. It allows also supple bracelets, e.g. of leather, to be fastened by means of a rigid attaching element that comes to rest in the lodging, integral with the middle, and covered by the protuberance of the rotating bezel when it is locked. This solution has the same disadvantages as the preceding one.

Patent FR709518 is a proposal similar to the preceding one, with an embodiment that is a formed case, i.e. not circular. The inconvenience of this invention, dating back to 1931, is that it no longer corresponds to the technical criteria of watches as they are designed nowadays.

### BRIEF SUMMARY OF THE INVENTION

The aim of the invention is achieved when the inner sides of the horns of the watch or of the jewel are at least partly not parallel. In a preferred embodiment, they present, as seen from above, a necking, for example in the shape of a T-groove, as shown in the embodiment illustrated in FIG. 1. This opening can in fact appear in different shapes, as long as they display a narrowing, or necking, along the horns.

This opening, made in the watch or in the jewel, can traverse the width of the middle through and through. It can also be made only to a certain depth, either from above or from below the middle.

Since the bracelet's strand has a shape similar to that of the aforementioned opening, it becomes integral with the watch or with the jewel, along the longitudinal axis through the opening's necking, and along the transverse axis through the two horns of the base element, for example of the middle in the case of a watch.

As the bracelet's strand does not comprise lugs, its locking on the vertical axis is ensured by a tongue, visible in FIG. 7, that is displaced by actuating a rotating element of the watch.

The system of horns is a common attachment of the watch. The present invention can also be adapted to other attaching systems, for example to a central attachment.

Thanks to this new design, the bracelet is integral with the watch or the jewel on its three axes. The fastening is thus ensured and reliable.

### BRIEF DESCRIPTION OF THE DRAWINGS

The embodiments of the invention, chosen as non-limiting examples, are now described with the aid of the following drawings in which:

FIG. 1 shows a watch case with the bracelet, according to the invention, seen from above.

FIG. 2 shows an identical watch case, seen from below.

FIG. 3 shows a cross-section along the half-axis A, represented in FIG. 1.

FIG. 4 shows a cross-section along the half-axis B, represented in FIG. 1.

FIG. 5 shows a cross-section along the half-axis C, represented in FIG. 1.

FIG. 6 shows a cross-section along the half-axis D, represented in FIG. 1.

FIG. 7 shows a view from below of the watch case, without the back cover, showing the rotating ring in locked position.

FIG. 8 shows a view from below of the watch case, without the back cover, showing the rotating ring in unlocked position.

FIG. 9 is a front view of a bracelet strand corresponding to the preceding ensemble.

FIG. 10 is a side view of the bracelet strand of FIG. 9.

### DETAILED DESCRIPTION OF POSSIBLE EMBODIMENTS OF THE INVENTION

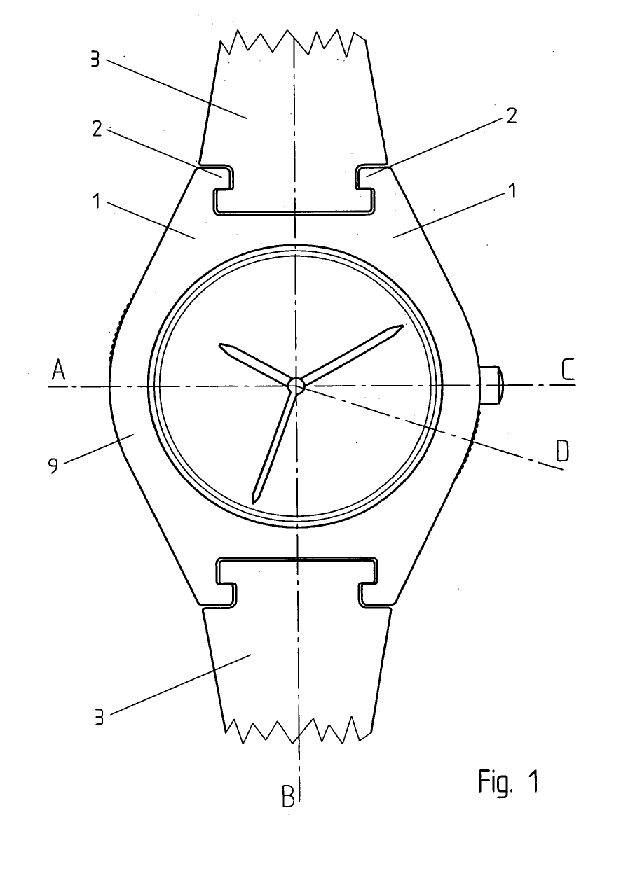

FIG. 1 represents a watch case and a bracelet according to a preferred embodiment of the invention, seen from above. The watch case comprises a middle 9 comprising two pairs of horns 1 for receiving each a strand 3 of a bracelet. The pairs of horns 1 are preferably situated at six o'clock and at twelve o'clock such that the bracelet is attached parallel to the longitudinal axis B. Other positions are however possible, thus resulting in different alignments of the bracelet relative to the watch case. In the embodiment of FIG. 1, the horns 1 present, at the extremity of the internal face, a necking 2 designed to lock the bracelet 3 along the longitudinal axis B. This implies that the extremities of the bracelet's two strands 3 that will lodged in-between the horns 1 will have the counter-shape of this space, in particular as regards part 2.

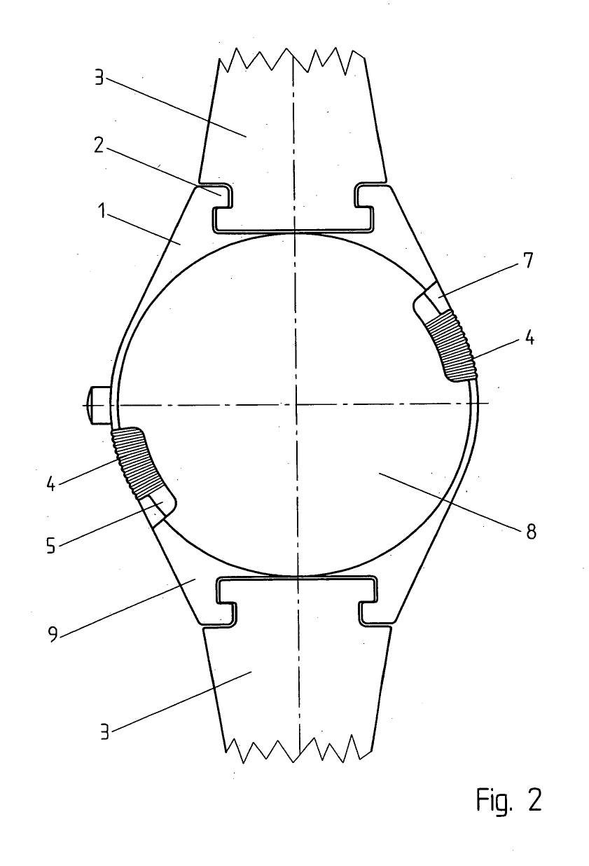

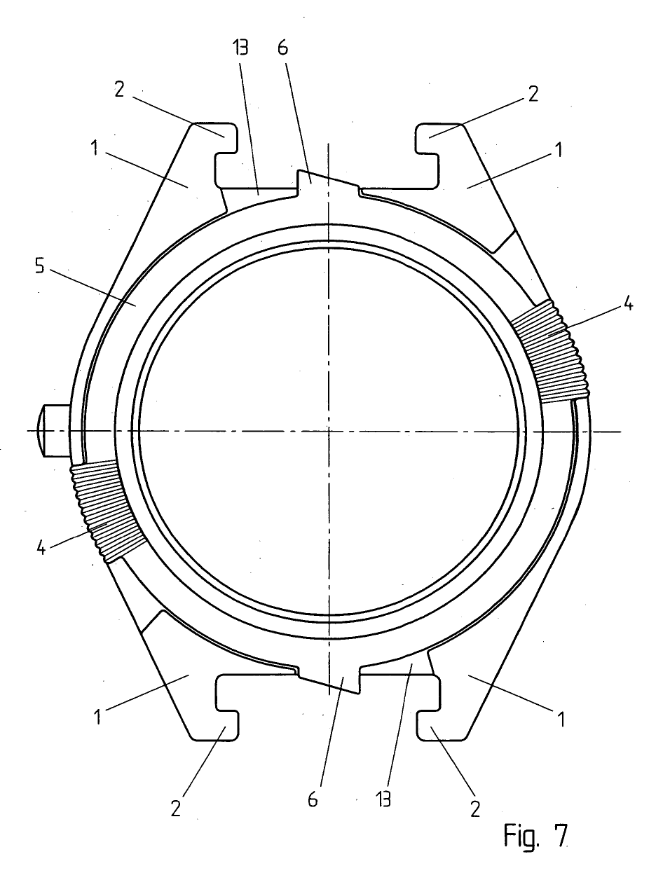

FIG. 2 is the same watch case seen from below. Unless specified, the same reference numbers designate the same elements in all figures. This view shows protuberances 4 that are part of a rotating ring 5, as well as tongues 6 (visible in FIG. 7) which are used for locking the strands of the bracelet 3. The protuberances 4 can move in a clearance 7 made in the bottom 8 and in the middle 9.

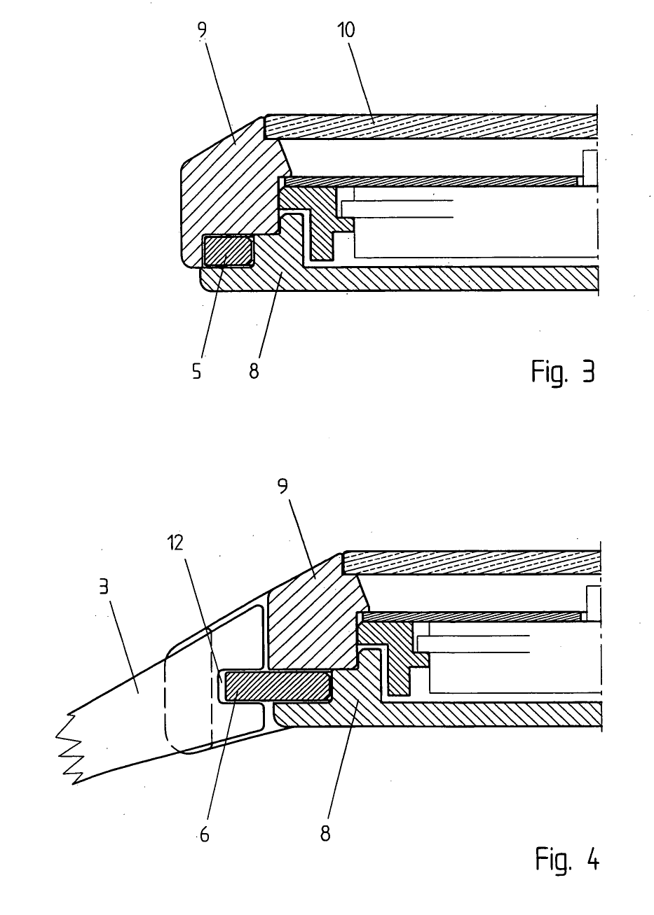

FIG. 3 is a cross-sectional view along the half-axis A, represented in FIG. 1. It shows in particular the position of the rotating ring 5 placed in-between the middle 9 and the back cover 8 so as to turn freely between these two parts. The glass of the watch 10 is also visible on this view.

FIG. 4 is a cross section along the half-axis B, represented in FIG. 1. This cross section makes the tongue 6 visible in the locking position of the strand of the bracelet 3. This tongue is part of the rotating ring 5 (not visible in this figure). This figure shows how the tongue 6 in its locked position is inserted in a recess 12 of the strand 3.

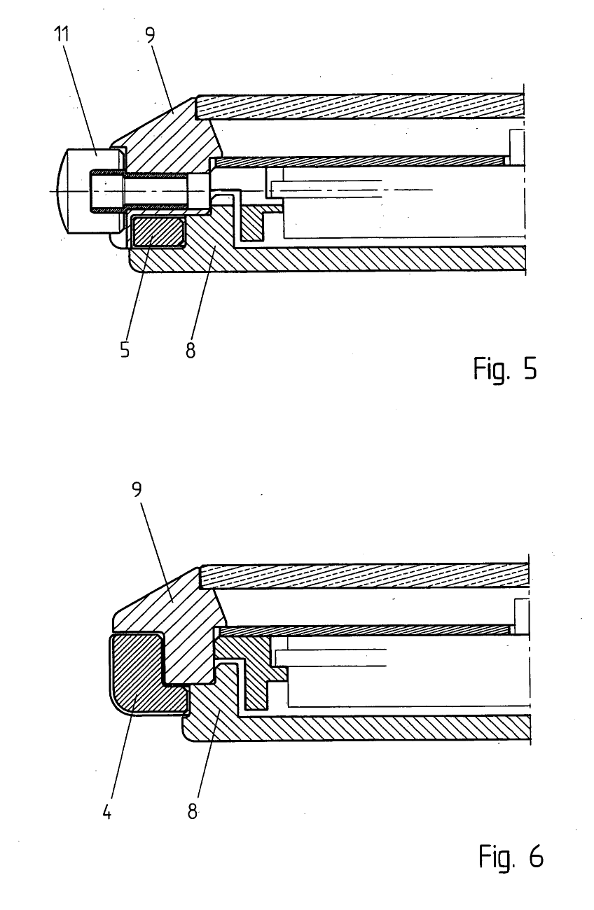

FIG. 5 is a cross section along the half-axis C, represented in FIG. 1. It shows the position of the rotating ring 5 relative to the winding button 11, mounted in the usual manner in the middle 9.

FIG. 6 is a cross section along the half-axis D, represented in FIG. 1. It shows one of the two protuberances 4 belonging to the rotating ring 5. They serve to move the tongues 6 causing the locking or unlocking of the bracelet strands.

FIG. 7 is a view from below of the watch case, without the back cover, showing the rotating ring 5 in locked position. The determinant elements of this rotating ring 5 are visible in this figure, namely the two protuberances 4 serving to move it and the two tongues 6 serving to lock and unlock the strands of the bracelet. In this position, the rotating ring 5 is placed such that the tongues 6 protrude in the openings defined by the pairs of horns 1 and are at an approximately equal distance of each horn 1 of the corresponding pair.

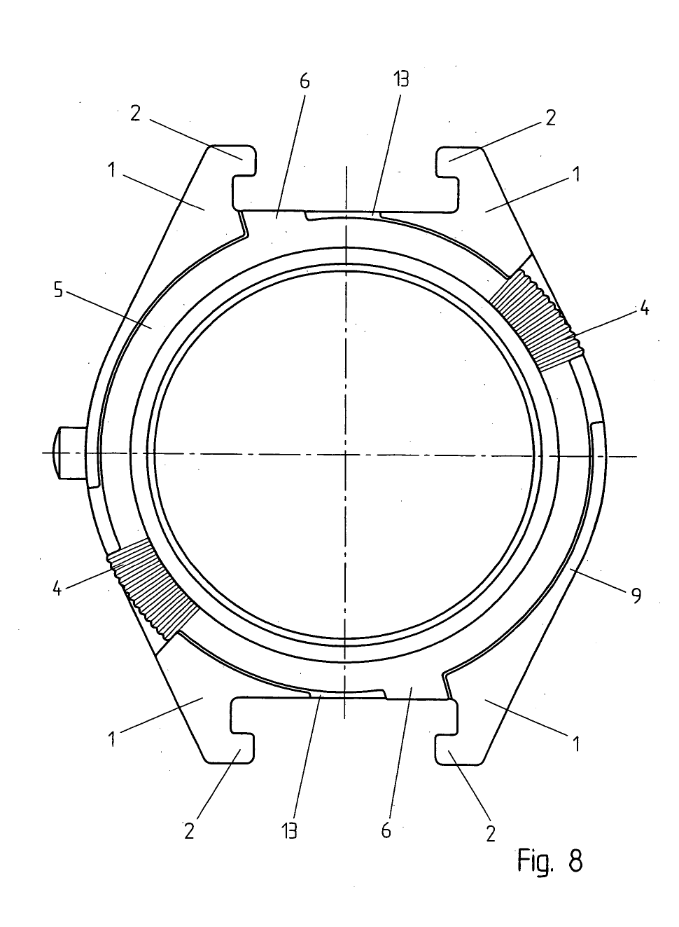

FIG. 8 is a view from below of the watch case, without the back cover, showing the rotating ring 5 in unlocked position. In this position, the tongues 6 preferably do not protrude in the openings defined between the pairs of horns 1 such that the extremities of the bracelet's strands can be inserted and removed from these openings. In this position, the bracelet's strands can thus be removed and for example replaced by others.

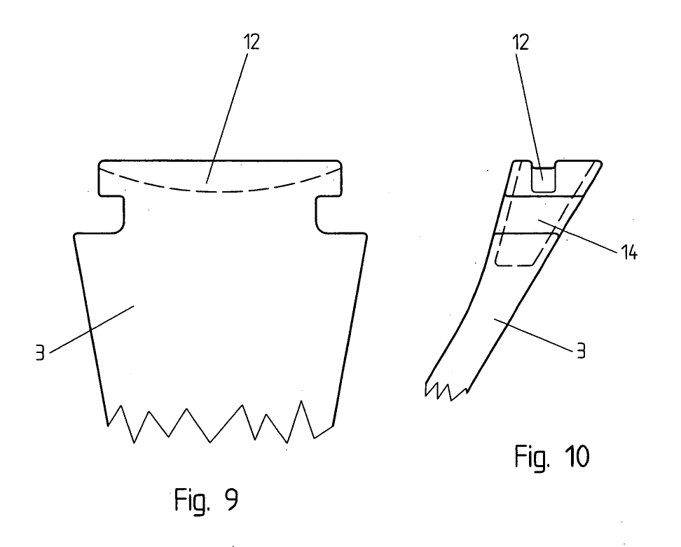

FIGS. 9 and 10 show a strand 3 of the bracelet corresponding to the preceding ensemble. It shows the strand's extremity, which is preferably reinforced by a rigid insert 14, and moulds itself to fit the shape of the space in-between the horns of the middle. In the side of the bracelet strand parallel to the transverse axis of the watch is a recess 12 in which the tongue is set when the strand 3 is put in place. The suitable rotation of the rotating ring 5 ensures the locking of the two strands of the bracelet 3 along the vertical axis. The rotating ring 5 is preferably held in this locked position by a holding device, not represented on the figures. The holding device includes for example a ratchet, or any other mechanism in order to maintain the position of the rotating ring 5 relative to the middle 9.

In the embodiment illustrated in the FIGS. 1 to 10, the horns 1 form a necking 2 on their entire height. The necking 2 is thus visible from the upper side and from the lower side of the watch when the bracelet is fastened to the case.

Other shapes are possible for the horns 1 within the framework of the invention. In a variant embodiment, the upper parts of the horns 1 have parallel inner sides and participate to the aesthetic aspect of the watch when a bracelet is fastened to the case, whilst the lower parts of their inner sides form a necking, for example as illustrated in the figures, in a dovetail shape, or in any other shape, and are preferably at least partly covered by the bracelet when the latter is fastened to the watch case.

According to still another embodiment, the upper parts of the horns form a necking close to the end of the horns whilst the inner sides of their lower part are parallel to the longitudinal axis. The necking is then for example visible from the upper side of the watch when the bracelet is fastened to the case and thus possibly contributes to the aesthetic aspect of the watch.

In the illustrated embodiment of the invention, both pairs of horns 1 and both tongues 6 are identical to each other. It is however possible, within the framework of the invention, to conceive a watch case or a jewel having two pairs of horns of different shapes. This further brings the advantage that both bracelet strands have differently shaped extremities, thus preventing them from being fastened to the wrong place.

The spacing delimited by two horns 1 of a same pair defines a lodging for the extremity of a bracelet strand 3. Preferably, the width of the strand's extremity is approximately equal to the distance between the inner sides of the horns 1, such that, when placed in its lodging, the strand 3 is held in both directions along a first axis, for example along the transverse axis A-C. According to the invention, the horns 1 of a same pair further form a necking on at least part of the horns' height, preferably close to the extremity of the horns 1. The strand's extremity is preferably rigid and formed to comply with this necking, such that the strand is held along a second axis, for example along the longitudinal axis A-C, when it is correctly placed in the lodging. In the illustrated example, the necking is in the shape of a rectangle. Other forms are however possible within the framework of the invention. The parts of the horns protruding within the lodging for holding the bracelet's strand in one or preferably both directions along the second axis can for example have circular, triangular or any other shapes.

When the bracelet fastening device of the invention is in locked position and a strand 3 is correctly placed in its lodging, the corresponding tongue 6 holds the strand in both directions along a third axis, for example along the vertical axis, through insertion in a corresponding recess 12 in the preferably rigid strand's extremity (FIG. 4).

In the illustrated example, the tongues 6 are united with the rotating ring 5 placed between the middle 9 and the back cover 8. According to a variant embodiment, the tongues 6 are united with another rotating element located for example over and/or inside the middle 9, for example a rotating bezel, a rotating lever, etc. The rotating element can then be accessed and actuated for example from the upper side and/or from a lateral side of the watch case. Preferably, both tongues are united with the same rotating element. It is however possible, within the framework of the invention, to unite each tongue 6 with a different rotating element, such that each strand can for example be locked or unlocked independently.

If a metallic bracelet is used, the first link has the shape and the elements allowing it to be set in the space in-between the horns of the watch case and to be fastened there according to the same principles of those described here above.

The invention is not limited to the use of bracelet strands with inserts or of metallic bracelets, nor to the attaching system described here above. It is enough for the part of the strands placed in the attachment of the middle 9, or of another base element, to be sufficiently rigid to be held by the attachment's necking, despite a traction being exerted on the strands.

The invention is described above in its application to a watch, in particular to a wrist watch, wherein the horns are preferably united with the watch case's middle. The bracelet fastening device of the invention can however also be applied to a jewel, whereas the horns are then united with a base element of a part of the jewel whilst the tongue or tongues are united with a rotating element which is attached to the base element and can slide relative to it.

1. A bracelet fastening device for watches and jewelry, wherein the watch or jewel has an attachment, for example two pairs of horns, constituted by an opening in the watch or jewel that can be in different shapes, for example in T-groove shape, as long as said opening displays a necking and is placed on at least one part of the thickness of the watch or jewel, and in that the extremity of a strand of the bracelet or metallic bracelet corresponding to said opening has a similar shape, so as to be positioned in this opening and become integral with the watch or jewel along a longitudinal axis and a transverse axis, whilst the locking of the strand of the bracelet or metallic bracelet along the vertical axis is ensured by at least one tongue introduced in at least one recess of the bracelet strand or metallic bracelet, said tongue being placed in this position following a rotation of a rotating element integral with the tongue and of at least one protuberance protruding from the watch or jewel, so as to be actuated manually.

2. A bracelet fastening device for watches and jewelry, wherein the watch or jewel has an attachment, for example a central attachment, constituted by an extension of the watch or jewel that can have different shapes, for example a T-shape, as long as said extension displays a necking and is placed on at least one part of the thickness of the watch or jewel, and in that the extremity of a strand of the bracelet or metallic bracelet corresponding to said extension has a similar shape, so as to envelop said extension and become integral with the watch or jewel along a longitudinal axis and a transverse axis, whilst the locking of the strand of the bracelet or metallic bracelet along the vertical axis is ensured by at least one tongue introduced in at least one recess of the bracelet strand or metallic bracelet, said tongue being placed in this position following a rotation of a rotating element integral with the tongue and of at least one protuberance protruding from the watch or jewel, so as to be actuated manually.

3. The bracelet fastening device for watches and jewelry of claim 1, wherein the watch or jewel is constituted of a base element comprising the horns that define by their internal side provided with at least one necking the opening designed to receive the extremity of the strand of the bracelet, said base element and said horns further having at least one hollow for the tongue to pass or to be lodged in unlocked position.

4. The bracelet fastening device for watches and jewelry of claim 2, wherein the watch or jewel has an attachment, for example a central attachment, constituted by an extension of the watch or jewel that can have different shapes, for example a T-shape, as long as said extension displays a necking and is placed on at least one part of the thickness of the watch or jewel, and by the fact that the extremity of a strand of the bracelet or metallic bracelet corresponding to said extension has a similar shape, so as to envelop said extension and become integral with the watch or jewel, said base element and said central attachment further having at least one hollow for the tongue to pass or to be lodged in unlocked position.

5. The bracelet fastening device for watches and jewelry of claim 1, wherein the opening is made through the entire thickness of the base element comprising the horns.

6. The bracelet fastening device for watches and jewelry of claim 1, wherein the opening is made from above or below the base element comprising the horns and on one part only.

7. The bracelet fastening device for watches and jewelry of claim 1, wherein the opening is made from below the base element comprising the horns and on one part only, whilst the rest of the width is open so that the space in-between the horns, visible from above, is parallel.

8. The bracelet fastening device for watches and jewelry of claim 1, wherein the strand of the bracelet can be put in place when the rotating element has been displaced by rotation so that the tongue is no longer in the opening of the base element comprising the horns, and said strand of the bracelet is locked with the tongue has been replaced in its initial locking position, namely in the opening of the base element comprising the horns and in the recess, furthermore that the rotating bezel is held in this position by a holding element, for example a ball bearing mounted on a spring or a ratchet.

9. The bracelet fastening device for watches and jewelry of claim 2, wherein the strand of the bracelet can put in place when the rotating element has been displaced by rotation so that the tongue or tongues are no longer in the space designed for the extremity of the strand of the bracelet, the latter being locked when the tongue has been replaced in its locking position, namely in the recess of the strand of the bracelet, furthermore that the rotating element is held in this position by a holding element, for example a ball bearing mounted on a spring or a ratchet.

10. The bracelet fastening device for watches and jewelry of claim 1, wherein the extremity of the strand of the bracelet is reinforced by an insert, rigid, in the face of which is the recess where are placed the tongues when the strand of the bracelet is locked.

11. The bracelet fastening device for watches and jewelry of claim 1, wherein said base element is a middle of a watch.

12. The bracelet fastening device for watches and jewelry of claim 2, wherein said base element is a middle of a watch.

13. The bracelet fastening device for watches and jewelry of claim 1, wherein said rotating element is a rotating ring.

14. The bracelet fastening device for watches and jewelry of claim 2, wherein said rotating element is a rotating ring.

15. A watch case or part of jewel comprising:
at least two cooperating horns for limiting the displacement of a bracelet strand along a longitudinal axis of said bracelet strand and a transverse axis of said bracelet strand,
a rotating element which can be rotated relative to said at least two cooperating horns between a locked position and an unlocked position so as to limit the displacement of said bracelet strand along a vertical axis of said bracelet strand in said locked position, and to allow the changing of said bracelet strand in said unlocked position, said vertical axis being perpendicular to said longitudinal axis and to said transverse axis.

16. The watch case or part of jewel of claim 15, said at least two cooperating horns being united with a base element, said at least two horns having a necking at their end on at least a part of their thickness,
said rotating element being attached to said base element such that it can be rotated relative to said base element between said locked position and said unlocked position.

17. The watch case or part of jewel of claim 16, said base element being a middle of a watch.

18. The watch case or part of jewel of claim 16, said rotating element being a rotating ring.

19. The watch case or part of jewel of claim 16, said necking having a “T” shape.

20. The watch case or part of jewel of claim 15, said rotating element comprising a tongue introduced in a recess in said bracelet strand when in said locked position.

21. The watch case or part of jewel of claim 20, said tongue being placed between said at least two cooperating horns in said locked position.

22. A bracelet strand comprising an extremity with a recess, said recess being at least partly closed on two opposite sides such that a tongue which would be introduced in said recess would be held in both directions along an axis perpendicular to said opposite sides.

23. The bracelet strand of claim 22, said extremity being rigid.

24. The bracelet strand of claim 23, said extremity being a rigid insert within said strand.

25. A watch or jewel, comprising:
a watch case or part of jewel,
a bracelet strand attached to said watch case or part of jewel,
said watch case or part of jewel comprising at least two cooperating horns for limiting displacement of said bracelet strand along a longitudinal axis of said bracelet strand and a transverse axis of said bracelet strand, and a rotating element which can be rotated relative to said at least two cooperating horns between a locked position and an unlocked position so as to limit the displacement of said bracelet strand along a vertical axis of said bracelet strand in said locked position, and to allow the changing of said bracelet strand in said unlocked position.

26. The watch or jewel of claim 25, said rotating element comprising a tongue, an extremity of said bracelet strand comprising a recess at least partly closed on two opposite sides, said tongue being inserted in said recess in said locked position, such that said tongue is held in both directions along an axis perpendicular to said opposite sides.

27. The watch or jewel of claim 25, said axis perpendicular to said opposite sides being parallel to said vertical axis.
